(19) United States
(12) Patent Application Publication
(10) Pub. No.: US 2009/0235048 A1
(43) Pub. Date: Sep. 17, 2009

(54) INFORMATION PROCESSING APPARATUS, SIGNAL TRANSMISSION METHOD, AND BRIDGE

(75) Inventors: Hideki Mitsubayashi, Tokyo (JP); Takeshi Yamazaki, Tokyo (JP); Hideyuki Saito, Tokyo (JP); Yuji Takahashi, Tokyo (JP)

Correspondence Address: KATTEN MUCHIN ROSENMAN LLP, 575 MADISON AVENUE, NEW YORK, NY, 10022-2585, US

(73) Assignees: SONY CORPORATION, Tokyo (JP); SONY COMPUTER ENTERTAINMENT INC., Tokyo (JP)

(21) Appl. No.: 12/159,040

(22) PCT Filed: Nov. 8, 2006
(86) PCT No.: PCT/JP2006/322243

§ 371 Date: Aug. 13, 2008

(30) Foreign Application Priority Data
Jan. 16, 2006 (JP) 2006-008002

(51) Int. Cl. G06F 15/76; G06F 9/02

(52) U.S. Cl. 712/29; 712/E09.002

(57) ABSTRACT

Introduced is an end-point bridge that relays an end point—formed by an external bus in a device tree managed by a first processor unit and an end point formed by an external bus in a device tree managed by a second processor unit. A conversion unit in the end-point bridge replaces a requestor ID contained in an access request packet, for example, which has reached the end point, to the ID of the end point from the ID of a host bridge. The ID of the host bridge is stored in a memory in a manner that the ID of the host bridge is associated with a tag of the packet, and is used to return the requestor ID when a response packet to the request reaches the end point.

### FIELD OF THE INVENTION

The present invention relates to an information processing technology, and in particular, to an information processing apparatus having a plurality of arithmetic processing units, a method for transmitting signals in the information processing apparatus, and a bridge to be mounted thereon.

### DESCRIPTION OF THE RELATED ART

Recently, computers have been diversified in their functions. Along with this, devices to be connected to the computers have also been diversified. Such devices exchange signals with a CPU via buses. Bus bridges are used to ensure the compatibility with different types of buses to connect a bus connected directly to the CPU with buses used to form ports for the device connection. Further, a device tree having the same kind of buses is formed by connecting the bus bridges hierarchically, thereby increasing the number of ports to which the device can be connected.

Also in recent years, an information processing apparatus of a multiprocessor architecture equipped with a plurality of processors or a multihost architecture equipped with a plurality of multiprocessor structures has generally been used to meet a demand for high-speed arithmetic processing. In these parallel processing technologies, a single application is distributed over a plurality of processors or a plurality of hosts to achieve high-speed processing. An exemplary structure of the multihost architecture is a fat-tree architecture (See Nonpatent Document 1, for instance).

[Nonpatent Document 1] C. E. Leiserson, “Fat-Trees: Universal Networks for Hardware-Efficient Supercomputing”, IEEE Transactions on Computer, Vol. 34, No. 10, pp. 892-901, 1985.

### DISCLOSURE OF THE INVENTION

### Problems to be Solved by the Invention

For example, when in the information processing apparatus having a multihost architecture the processing is to be done by distributing a single application over a plurality of hosts, the bus to be managed differs for each host. Hence, mutual accesses among different device trees become complicated. Increasing the number of hierarchies in a device tree to cope with the required increase in the number of ports results in the number of buses to be managed. This may often turn out disadvantageous in terms of managing the buses in the processors or the speed at which the signals are received from and transmitted to a connected device.

The present invention has been made in view of the foregoing problems to be resolved and a general purpose thereof is to provide a technology capable of flexibly meeting a wide variety of devices connected.

### Means for Solving the Problems

One embodiment of the present invention relates to an information processing apparatus. This information processing apparatus comprises: two processor units; two device trees managed by the two processor units, respectively; and a bridge which relays signal transmission between two end points formed by the two device trees, respectively, wherein the bridge inputs a signal obtained after information, contained in an output signal from one of the two end points, which is valid in the device tree to which the one of the two end points belongs has been converted into information that is valid in the device tree to which the other end point belongs, to the other end point.

The device tree is a structure where bridges are connected in tree-like multiple stages starting from a root node at which a processor unit is located and thereby access to devices located at ends of a tree, namely at end points, is possible. In this device tree structure, bridges, buses and end points that constitute a tree are each identified and managed by a processor unit located at the root node. “Information which is valid in the device tree” is local information required, for example, when the processor unit located at the root node controls the signal transmission within a device tree to be managed. It includes information, by which to identify the position within each device tree, such as identification numbers assigned individually to bridges, buses, end points and the like.

Another embodiment of the present invention relates to a method for transmitting-signals. This signal transmission method includes: transmitting a signal from a first processor unit to a second processor unit; transmitting the signal to a first end point that belongs to a first device tree managed by the first processor unit; converting information, contained in the signal outputted from the first end point, which is valid in the first device tree, into information valid in a second device tree managed by the second processor unit; inputting the converted signal to a second end point that belongs to the second device tree; and transmitting the converted signal to the second processor unit.

Another embodiment of the present invention relates to a bridge. The bridge comprises: an input/output unit which inputs and outputs a signal to and from two end points belonging to device trees managed by different processor units; and a conversion unit which generates a signal in a manner that information, contained in the signal outputted from one of the two end points, which is valid in a device tree to which the one of the two end points belongs, is converted into information valid in a device tree to which the other end point belongs, and which inputs the converted signal to the other end point.

Optional combinations of the aforementioned constituting elements, and implementations of the invention in the form of methods, apparatuses, systems, computer programs and so forth may also be effective as additional modes of the present invention.

### Effects of the Invention

According to the present invention, an information processing technique meeting a diversity of connection devices can be realized.

### BRIEF DESCRIPTION OF DRAWINGS

FIG. 1 illustrates an exemplary structure of a device tree in an information processing apparatus that includes a single processor unit;

FIG. 2 schematically shows a structure where signals are transmitted and received between two processor units;

FIG. 3 is a flowchart showing a processing procedure for transmitting and receiving signals between two processor units;

FIG. 4 illustrates an exemplary data structure of a requester ID table;

FIG. 5 illustrates a structure of an information processing apparatus having a fat-tree architecture to which the present embodiment is applied;

FIG. 6 schematically illustrates a structure of an information processing apparatus having a fat-tree architecture to which the present embodiment is applied;

FIG. 7 schematically illustrates a structure of an information processing apparatus having a fat-tree architecture to which the present embodiment is applied.

### DESCRIPTION OF REFERENCE NUMERALS

10 . . . Information processing apparatus, 12 . . . Processor unit, 14 . . . External bus, 16 . . . Bridge chip, 17 . . . Switch chip, 18 . . . End point, 20 . . . Internal bus, 22 . . . Host bridge, 24 . . . Bus bridge, 30 . . . End-point bridge, 40 . . . Requestor ID table, 50 . . . Information processing apparatus

### THE BEST MODE FOR CARRYING OUT THE INVENTION

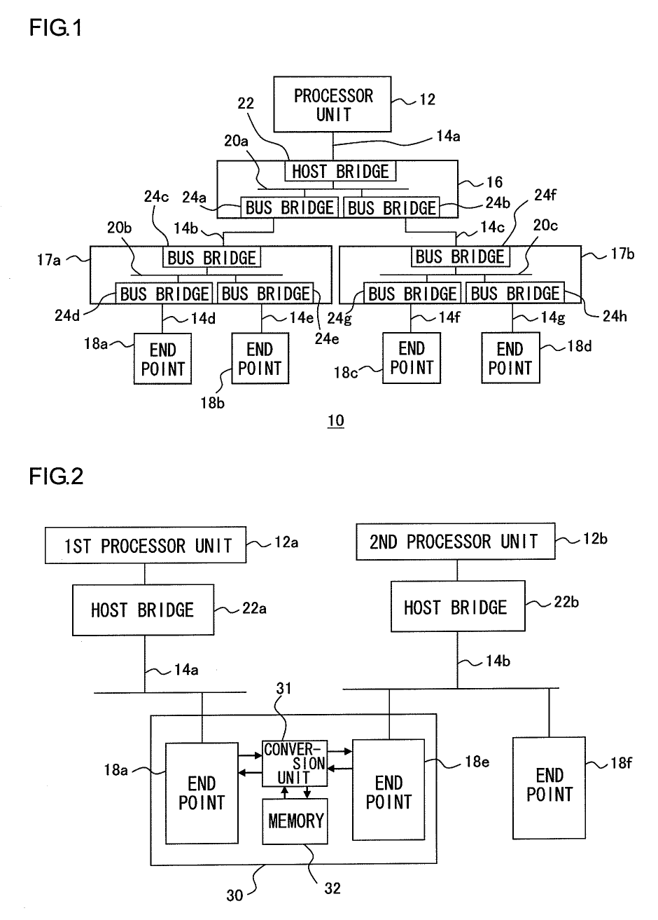

A description is first given of a structure of a device tree used in the present embodiment. FIG. 1 illustrates an exemplary structure of a device tree in an information processing apparatus that includes a single processor unit. This structure can be realized by the use of a bus architecture of PCI (Peripheral Component Interconnect), for example. An information processing apparatus 10 includes a processor unit 12 which performs arithmetic processing, a bridge chip 16 which relays the communication of signals between the processor unit 12 and other units, switch chips 17a and 17b each of which branches the path of signals outputted by the bridge chip 16 and selects a path as appropriate so as to be transferred, and end points 18a, 18b, 18c and 18d each of which provides an interface with a device that receives input from and transmits output to the switch chip 17a or 17b. The processor unit 12, the bridge chip 16, the switch chip 17a or 17b, and the end point 18a, 18b, 18c or 18d transmit and receive the signals via external buses 14a to 14g, respectively.

The processor units 12 are of a multi-processor structure constituted by a plurality of processors, for instance. The processor units 12 may include, as appropriate, main memories, I/O interfaces, etc., which are not shown. The bridge chip 16 includes a host bridge 22 which relays the local bus 14a of the processor unit 12 to a bus such as PCI used to connect a peripheral device. The host bridge 22 is connected to bus bridges 24a and 24b by an internal bus 20a. Like a PCI-to-PCI bridge, for example, the bus bridges 24a and 24b relay the signal transmission by the same type of buses. The same applies to the bus bridges 24 described later.

The switch chip 17a includes bus bridges 24c, 24d and 24e. The switch chip 17b includes bus bridges 24f, 24g and 24h. The two bus bridges 24a and 24b in the bridge chip 16 are connected to the bus bridge 24c in the switch chip 17a and the bus bridge 24f in the switch chip 17b via the external buses 14b and 14c, respectively.

In the switch chip 17a, the bus bridge 24c is connected to the other bus bridges 24d and 24e through an internal bus 20b. The bus bridges 24d and 24e are connected to the external buses 14d and 14e, respectively, and their respective external buses 14d and 14e constitute the end points 18a and 18b. The switch chip 17b has a similar structure to the switch chip 17a. The bus bridges 24g and 24h are connected to the external buses 14f and 14g and their respective external buses 14f and 14g constitute the end points 18c and 18d.

Increasing the number of external buses 14 by connecting the bus bridges 24 in this tree-shaped manner allows the increase in the number of end points 18. Though the number of bridges provided in the bridge chip 16 and the switch chips 17 is set to three for simplicity, this should not be considered as limiting. Also, the number of switch chips 17 is not limited to two, and the number of end points 18 may be increased, as appropriate, by branching the external bus 14 in multiple stages. It is also possible to connect one of the two bus bridges 24 to a switch chip 17 to further ramify them and form the other bridge 24 as the end point 18.

A device connected to an end point 18 is identified within a device tree by a combination of the bus number which is an identification number given to each external bus 14 and the device number to identify a device connected to an end point 18 formed by a bus. An access between a processor unit 12 or memory contained in the processor unit 12 and each device is requested and established based on the combination of the bus number and the device number.

The information processing apparatus according to the present embodiment is of a structure having a plurality of information processing units 12 by combing a plurality of information processing apparatuses each of which is the information processing apparatus 10 shown in FIG. 1. In this embodiment, signals transmitted through the external buses 14 and the like under control of one processor unit 12 can be transferred through another external buses 14 and the like under control of another processor unit 12 via the end points 18. FIG. 2 schematically shows a structure where signals are transmitted and received between device trees in two processor units. Although, for simplicity, only the host bridges 22 and the end points 18 managed by the processor unit 12 are shown in the figure, the bus bridges 24 may be provided on the path leading from the host bridges 22 to the end points 18 as shown in FIG. 1. Accordingly, the end points 18 are also formed in plurality as shown in FIG. 1, but they are omitted here.

In a device tree managed by a first processor unit 12a, an end point 18a is formed through the presence of a host bridge 22a, an external bus 14a and the like. Similarly, in a device tree managed by the second processor unit 12b, end points 18e and 18f are formed through the presence of a host bridge 22b, an external bus 14b and the like. Introduced here is an end point bridge 30 that relays signal transmission between the end point 18a under control of the first processor unit 12a and the end point 18e under control of the second processor unit 12b.

The end-point bridge 30 includes a conversion unit 31 which converts a signal outputted from the end point 18a or the end point 18b so as to be inputted to the other end point, and a memory 32 which stores data necessary for the conversion in the conversion unit 31. For instance, a signal transmitted from the first processor unit 12a to the second processor unit 12b is first transmitted to the end point 18a. Then the signal is subjected to conversion in the end point bridge 30 and is transmitted from the end point 18e to the second processor unit 12b. A description is hereinafter given of a transmission technique using an example of a packet requesting access from the first processor unit 12a to the second processor unit 12b or a device under control of the second processor unit 12b.

As described above, access is requested and established based on the bus number and the device number. Thus the packet that has reached the end point 18a contains an requester ID including the bus number and the device number of a requester. In the above example, the bus number and the device number of the host bridge 22a is the requester ID. This is converted by the conversion unit 31, so that the requester ID is now the bus number and the device number of the end point 18e. As a result, a packet valid within a device tree under control of the second processor unit 12b is produced. Hence, the packet can reach desired unit or device in the tree. The same applies to the transmission of a packet destined to a device tree of the first processor unit 12a from a device three of the second processor unit 12b.

Considered here is a case where the second processor unit 12b, which has received a transmitted request packet, transmits a response packet to a request. Since in the device tree of the second processor unit 12b the requester ID contained in the request packet is the bus number and the device number of the end point 18e, the response packet is first transmitted to the end point 18e. Consequently, the conversion unit 31 in the end-point bridge 30 converts the response packet and then generates a response packet valid within the device tree of the first processor unit 12a.

At this time, the requester ID contained in the response packet needs to be changed back to the bus number and the device number of the host bridge 22a connected to the first processor unit 12a in order that the host bridge 22a of the first processor unit 12a, which is the original source of request, can receive the response packet. In the light of this, when the request packet is to be first converted by the conversion unit 31, the bus number and the device number of the host bridge 22a that is the original source of request are stored in the memory 32, as a requester ID table, by associating them with tags given to the same packet, in the present embodiment. The tags are the identification numbers uniquely determined for the request and response to establish an access.

When the response packet reaches the end point 18e, the conversion unit 31 acquires an requester ID in a tree of the first processor unit 12a, namely the ID of the host bridge 22a that is a future source of request, by referring to the requester ID table based on the tags contained in the response packet. Then the acquired ID is substituted with the requester ID contained in the response packet, so that a response packet valid within the device tree of the first processor unit 12a is generated. The thus generated response packet is sent to the host bridge 22a from the end point 18a, at which time the response to the access request made by the first processor unit 12a is completed.

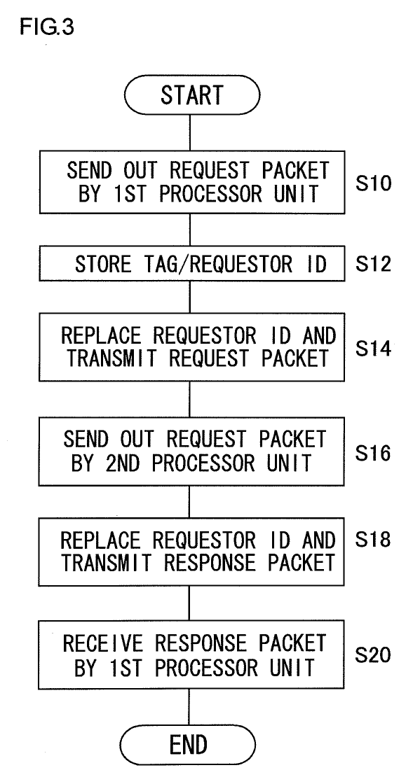

FIG. 3 is a flowchart showing the above-described processing procedure. First, the host bridge 22a sends out an access request from the first processor unit 12a to the second processor unit 12b, to the end point 18a under control of the first processor unit 12a as a request packet (S10). Here, the requester ID is constituted by the bus number and the device number of the host bridge 22a. As the request packet reaches the end point 18a, the conversion unit 31 in the end-point bridge 30 stores a tag and a requestor ID contained in the request packet, in a requester ID table in the memory 32 (S12). Then the requester ID is replaced by the bus number and the device number of the end point 18e and is transmitted to within the device tree of the second processor unit 12b (S14).

As the request packet has reached the host bridge 22b of the second processor unit 12b and thereby the second processor unit 12b recognizes this request, the response packet is sent out as appropriate via the host bridge 22b (S16). The tag at this time is the same as the tag contained in the request packet, and the destination is the end point 18e under control of the second processor unit 12b. As the response packet has reached the end point 18e, the conversion unit 31 acquires an original requester ID associated with the tag, from the requester ID table stored in the memory 32, and replaces the requester ID of the response packet. Then the signal is inputted to the end point 18a so as to be transmitted to within the device tree of the first processor unit 12a (S18). Then the first processor unit 12a receives the response packet via the host bridge 22a (S20). Thereby, the access request and the response between the two processor units 12a and 12b is completed.

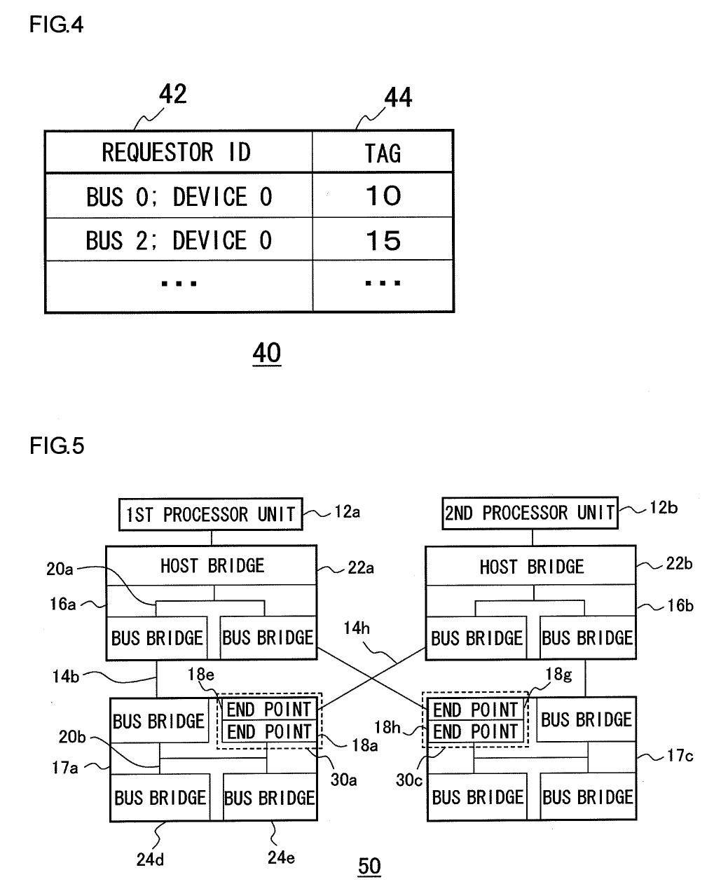

FIG. 4 illustrates an exemplary data structure of a requester ID table stored in the memory 32 within the end-point bridge 30. The requester ID table 40 contains a requester ID column 42 and a tag column 44. Requestor IDs contained in request packets, namely the bus numbers and the device numbers of bridges or device that are original request sources, are stored in the requester ID column 42. Tags, for establishing the access, contained in requester packets are stored in the tag column 44. The bidirectional transmission of packets can be managed by the tags stored in the tag column 44.

FIG. 5 schematically illustrates a structure of an information processing apparatus when the present embodiment is applied to the information processing apparatus having a fat-tree architecture constituted by two processor units 12a and 12b. Introduced here are bridge chips 16a and 16b and switch chips 17a and 17c connected to four-lane buses. In an information processing apparatus 50, the switch chip 17a under control of the first processor unit 12a includes an end-point bridge 30a, and the first processor unit 12a manages an end point 18a shown on the bottom of the end-point bridge 30a. The other end point 18e included in the end-point bridge 30a is managed by the second processor unit 12b. An end point 18g included in an end-point bridge 30c of the switch chip 17c is managed by the first processor unit 12a, whereas an end point 18h is managed by the second processor unit 12b.

In the figure, the bus numbers, “0”, “1” and “2” are, for example, assigned respectively to the internal bus 20a, the external bus 14b and the internal bus 20b. For example, the device numbers, “0”, “1” and “2” are assigned respectively to the bus bridges 24d and 24e and the end point 18a, which are connected to the internal bus 20b. Accordingly, the end point 18a is identified by an ID of “bus:2, device:2” in the device tree of the first processor unit 12a. If, on the other hand, the external bus 14h has, for example, the bus number 3 in the device tree of the second processor unit 12b, the end point 18e included in the end-point bridge 30a will be identified by an ID of “bus:3, device:0”. It goes without saying that there may be bridges or end points having the same ID in two different devices.

In the above-described example, “bus:0, device:0” which is the ID of the host bridge 22a is set as the requester ID in the request packet that is requested from the host bridge 22a of the first processor unit 12a. When the request packet is relayed from the end point 18a to the end point 18e in the end-point bridge 30a, the requester ID is replaced by “bus:3, device:0” in the conversion unit 31 and is transmitted to the second processor unit 12b. For the response packet, the requester ID, namely the ID of the destination of the response packet, is returned to “bus:0, device:0” from “bus:3, device:0” and is transmitted to the first processor unit 12a.

With the above operation, the packet used for a device tree formed by a single processor unit is applicable to a plurality of device trees respectively constituted by a plurality of processor units, without changing its format in any way. The initializing necessary for the establishment of a device tree, such as assignment of the bus numbers or device numbers and device detection, can be performed in the same way as what is generally exercised for a single processor unit. Hence, a system having a plurality of processor units can be easily structured.

Also, according to the present embodiment, the original requester ID is completely replaced with the identification information of the other end point. Thereby, in comparison with the case where the original requester ID is still contained in the request packet, the size of the request packet and the response packet can be saved. Further, although the packets are to be transmitted and received via three or more device trees each managed by a different processor unit, there is no need for changing its format in any way and no need for enlarging the size of packets.

In the examples described so far, a description has been given of packet transmission and reception between the two processor unit 12a and 12b. It is also possible to transmit packets to yet another device tree relayed through a certain device tree by repeating the similar conversion in end point bridges. Thereby, the number of buses accessible by a single processor unit can be increased without increasing the number of buses managed by the processor unit. Hence, a large-scale system can be easily achieved by using efficient resources.

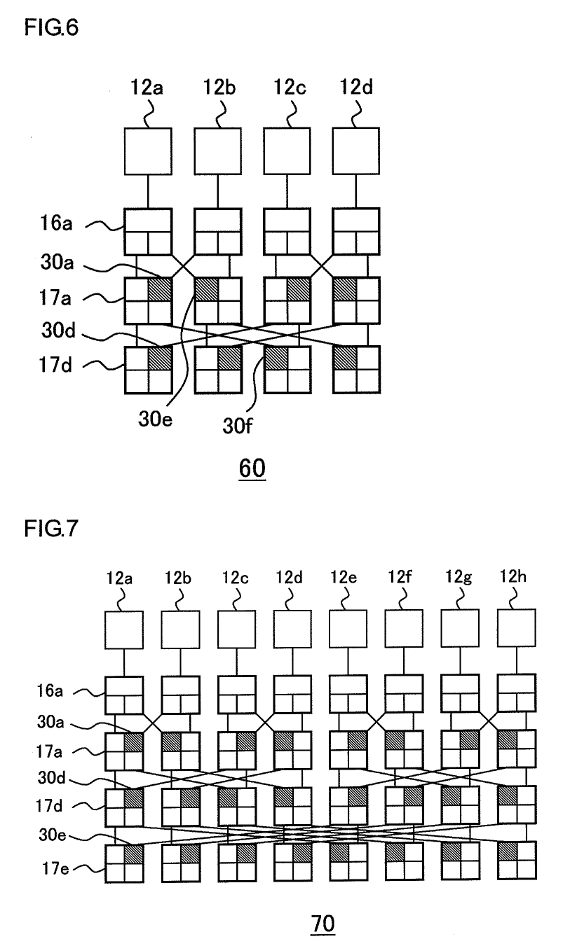

FIG. 6 schematically illustrates an information processing apparatus achieved when the above-described embodiment is applied to the information processing apparatus having a fat-tree architecture constituted by four processor units. An information processing apparatus 60 includes a first processor unit 12a, a second processor unit 12b, a third processor unit 12c, and a fourth processor unit 12d. The first processor unit 12a manages a bridge chip 16a and switch chips 17a and 17d. Three or four rectangles within each chip indicate bridges, and those with oblique lines in the switch chips 17a and 17d are end-point bridges 30a and 30d, respectively. The second processor unit 12b, the third processor unit 12c and the fourth processor unit 12d have the same structure.

The end-point bridge 30a relays signal transmission between an end point under control of the first processor unit 12a and an end point under control of the second processor unit 12b. The end-point bridge 30d relays signal transmission between an end point under control of the first processor unit 12a and an end point under control of the third processor unit 12c. Further, one ends of the end points connected in the end-point bridge 30e and the end-point bridge 30f are also under control of the first processor unit 12a. By employing such a structure, access to all other device trees from each processor unit 12 becomes feasible.

Similarly, FIG. 7 schematically illustrates an information processing apparatus having a fat-tree architecture constituted by eight processor units. An information processing apparatus 70 includes first to eighth processor units 12a to 12h. For example, the first processor unit 12a manages a bridge chip 16a and three switch chips 17a, 17d and 17e. Similarly, the second to eighth processor units 12b to 12h each manages three switch chips in addition to a bridge chip. Similar to FIG. 6, the rectangles with oblique lines in FIG. 7 also indicate end-point bridges (e.g. 30a, 30d and 30e). By employing such a structure, access to all other device trees from each processor unit 12 becomes possible in the same way as with FIG. 6.

According to the foregoing present embodiments, end-point bridges that connect end points belonging to device trees of the respective processor units are brought into use in the information processing apparatus having a plurality of processor units. And the signals passing the end points are converted, thereby producing the signals valid within the device trees in their destinations. This allows a processor unit or a device in the destination device tree to transmit signals in the same way as the case of the structure with a single processor unit, regardless of which device tree sent the signals.

Also, the device trees can be constructed in the same way as is a single processor unit. Thus, access can be easily achieved between a processor unit and various kinds of connection devices. Further, device trees of the other processor units may be used, so that the number of usable devices can be markedly increased according to the number of processor units without an increase in the number of switch chips managed by each processor unit. The present embodiments can be achieved by incorporating bridges into switch chips and therefore a large-scale system is constructed easily.

The invention has been described based on the exemplary embodiments. The above-described embodiments are intended to be illustrative only and it will be obvious to those skilled in the art that various modifications to any combination of constituting elements and processes could be developed and that such modifications are also within the scope of the present invention.

### INDUSTRIAL APPLICABILITY

As described above, the present invention can be used for computers, large-scale information processing systems and the like.

1. An information processing apparatus, comprising:
two processor units;
two device trees managed by the two processor units, respectively; and
a bridge which relays signal transmission between two end points formed by the two device trees, respectively,
wherein the bridge inputs a signal obtained after identification information, contained in an output signal from the one of the two end points, on a sender of the output signal in the device tree to which the one of the two end points belongs to has been rewritten to identification information on the other end point, to the other end point.

2. (canceled)

3. An information processing apparatus according to claim 1,
wherein the bridge includes a memory which stores the identification information contained in the output signal from the one of the two end points, on the sender, and
when a response signal generated in response to the output signal is outputted from the other end point, the bridge inputs the signal obtained after the identification information, contained in the response signal, on the other end point has been rewritten to the identification information on the sender stored in the memory, to the one of the two end points.

4. An information processing apparatus according to claim 1,
wherein the identification information on the sender is information set to identify each device in a device tree to which the sender belongs.

5. An information processing apparatus according to claim 3,
wherein identical signal identification information is appended to the output signal and the response signal in response thereto,
wherein the memory stores the identification information on the sender in associating with the signal identification information, and
wherein the bridge rewrites the identification information on the other end point contained in the response signal to the identification information on the sender, based on the signal identification information stored in the memory.

6. An information processing apparatus according to claim 1, having a fat-tree architecture, further comprising: a plurality of the bridges; a plurality of the device trees where signal transmission between end points is relayed by each bridge; and a plurality of the processor units which manage the plurality of the device trees, respectively.

7. A method for transmitting signals, including:
transmitting a signal from a first processor unit to a second processor unit;
transmitting the signal to a first end point that belongs to a first device tree managed by the first processor unit;
rewriting information, contained in the signal outputted from the first end point, on a sender of the signal, to identification information on a second end point that belongs to a second device tree managed by the second processor unit, from identification information on the first processor unit;
inputting the rewritten signal to the second end point; and
transmitting the inputted signal to the second processor unit.

8. A method for transmitting signals according to claim 7, the rewriting including storing the identification information on the first processor unit, in a memory, and
the method further including:
transmitting a response signal in response to the signal transmitted to the second processor unit, from the second processor unit to the second end point as a destination, according to the information contained in the signal transmitted to the second processor unit, on the sender;
transmitting the response signal to the second end point;
rewriting information, contained in the response signal outputted from the second end point, on a destination of the response signal, to identification information, stored in the memory, on the first processor unit, from identification information on the second end point;
inputting the rewritten response signal to the first end point; and
transmitting the inputted response signal to the first processor unit.

9. A bridge, comprising:
an input/output unit which inputs and outputs a signal to and from two end points belonging to device trees managed by different processor units; and
a conversion unit which generates a signal in a manner that identification information, contained in the signal outputted from one of the two end points, on a sender of the output signal in a device tree to which the one of the two end points belongs, is rewritten to identification information on the other end point, and which inputs the rewritten signal to the other end point.
